(19) United States
(12) Patent Application Publication
(10) Pub. No.: US 2026/0295907 A1
(43) Pub. Date: Oct. 1, 2026

(54) A Foam-Based, Structural Construction Panel

(71) Applicant: BTRboard Inc., Calgary (CA)

(72) Inventors: Les Dyduch, Alberta (CA); Colin Vernon Steele, Calgary (CA)

(21) Appl. No.: 19/477,645

(22) PCT Filed: Apr. 29, 2024
(86) PCT No.: PCT/CA2024/050577

§ 371 Date: Oct. 22, 2025

Related U.S. Application Data
(60) Provisional application No. 63/499,037, filed on Apr. 28, 2023.

(51) Int. Cl. B29C 44/12; B29K 75/00; B29K 105/04; B29L 31/00; C08G 71/04; C08J 9/00; E04C 2/288; E04C 2/296

(52) U.S. Cl. CPC B29C 44/1209; C08G 71/04; C08J 9/00; E04C 2/288; E04C 2/296; B29K 2075/00; B29K 2105/046; B29L 2031/776

(57) ABSTRACT

Described herein is a method for the formation of a PUR or PIR based construction product to be used in applications that currently use as an insulated sheathing product for building construction. Specifically, a PUR or PIR closed cell, rigid insulation foam is chemically and mechanically bonded to a suitable porous construction board to form the foam-based, structural construction panel.

### PRIOR APPLICATION INFORMATION

The instant application claims the benefit of U.S. Provisional Patent Application Ser. No. 63/499,037, filed Apr. 28, 2023 and entitled “POLYURETHANE-BASED CONSTRUCTION PRODUCT”, the entire contents of which are hereby incorporated herein by reference for all purposes.

### BACKGROUND OF THE INVENTION

Wall and roof panel construction systems known in the art are typically cumbersome and difficult to install properly so that maximum water/moisture repulsion and maximum heat retention is attained.

Ideally, a suitable construction panel should act as a barrier to bulk water, excess air and heat transfer, irritants, insects and mold.

### SUMMARY OF THE INVENTION

According to a first aspect of the invention, there is provided a method of preparing a foam-based, structural construction panel comprising:
mixing a polyol with additives to form a resin mixture;
blending the resin mixture with a suitable compound comprising isocyanate reactive groups to produce a polyurethane (PUR) or polyisocyanurate (PIR) closed cell, rigid insulation foam;
dispensing the PUR or PIR closed cell, rigid insulation foam onto a porous structural board, said porous structural board in a mold, said mold comprising at least one plate and said mold arranged to contain the PUR or PIR closed cell, rigid insulation foam between the structural panel and an opposite surface of the finished panel;
subjecting the PUR or PIR closed cell, rigid insulation foam on the porous structural board in the mold to suitable temperature for a suitable period of time such that said PUR or PIR closed cell, rigid insulation foam enters into pores of the porous structural board and thereby bonds to the porous structural board, thereby forming a foam-based, structural construction panel.

According to another aspect of the invention, there is provided a method of preparing a foam-based, structural construction panel comprising:
mixing a polyol with additives to form a resin mixture;
blending the resin mixture with a suitable compound comprising isocyanate reactive groups to produce a polyurethane (PUR) or polyisocyanurate (PIR) closed cell, rigid insulation foam;
dispensing the PUR or PIR closed cell, rigid insulation foam onto a porous structural board, said porous structural board in a mold, said mold comprising at least one plate and said mold arranged to contain the PUR or PIR closed cell, rigid insulation foam between the structural panel and an opposite surface of the finished panel and sidewalls to contain the foam on four sides;
subjecting the PUR or PIR closed cell, rigid insulation foam on the porous structural board in the mold to suitable temperature for a suitable period of time such that said PUR or PIR closed cell, rigid insulation foam enters into pores of the porous structural board and thereby bonds to the porous structural board, thereby forming a foam-based, structural construction panel.

According to another aspect of the invention, there is provided a method of preparing a foam-based, structural construction panel comprising:
mixing a polyol with additives to form a resin mixture;
blending the resin mixture with a suitable compound comprising isocyanate reactive groups to produce a polyurethane (PUR) or polyisocyanurate (PIR) closed cell, rigid insulation foam;
dispensing the PUR or PIR closed cell, rigid insulation foam onto a porous structural board, said porous structural board in a mold, said mold comprising at least one plate and said mold arranged to contain the PUR or PIR closed cell, rigid insulation foam between the structural panel and an opposite surface of the finished panel and sidewalls to contain the foam on two sides;
subjecting the PUR or PIR closed cell, rigid insulation foam on the porous structural board in the mold to suitable temperature for a suitable period of time such that said PUR or PIR closed cell, rigid insulation foam enters into pores of the porous structural board and thereby bonds to the porous structural board, thereby forming a foam-based, structural construction panel.

According to another aspect of the invention, there is provided a foam-based, structural construction panel prepared according to any one of the above-described methods.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

Described herein is a method for the formation of a foam-based construction product to be used in applications that currently use as an insulated sheathing product for building construction.

Specifically, prior art methods teach using connectors and/or adhesives to attach foam panels prepared separately to the surface of structural boards. As such, while when an adhesive is used, that adhesive may enter into the pores of a porous structural board, in the prior art insulated sheathing products, the foam panels are mounted onto the surface of the structural board.

In contrast, while not wishing to be bound to a particular theory or hypothesis, the inventors believe that the dispensing of the PUR or PIR closed cell, rigid insulation foam onto the porous structural board in the mold forces or drives some or a quantity of the PUR or PIR closed cell, rigid insulation foam into the structural board, that is, into pores of the structural board such that as the foam mixture expands and hardens, the foam is bonded to the structural board. As will be appreciated by one of skill in the art, as a result of dispersing the injected suitable rigid foam mixture directly onto the structural board, restriction of the expansion of the foam by containment of the mold creates pressure which in turn forces the foam into the pores, wherein the foam may react chemically with the porous structural board but the foam is also forced downward and outward in the pore, which results in a more secure bonding. This is of course in addition to the foam interacting with the outer surface of the porous structural board. Specifically, pressure is created by the restriction of the foam in the mold, by the temperature, which controls the speed of expansion, and the amount of foam that is added to a particular mold. Furthermore, a similar reaction will take place with suitable facer materials, as discussed herein. Specifically, the foam may enter the pores of the porous structural board and/or the pores of the facer material at a depth of about 0.4 mm (about 0.016 inches) to about 75 mm (about 3 inches), depending on the width of the porous structural board or facer, as discussed herein.

For example, the foam may enter the pores of the structural board or may penetrate the surface of the structural board so as to be at least about 0.4 mm, at least about 0.5 mm, at least about 0.6 mm, at least about 0.7 mm, at least about 0.8 mm, at least about 0.9 mm, at least about 1.0 mm, at least about 1.1 mm, at least about 1.2 mm, at least about 1.3 mm, at least about 1.4 mm, at least about 1.5 mm, at least about 2.0 mm, at least about 3.0 mm, at least about 4.0 mm, at least about 5.0 mm, at least about 6.0 mm, at least about 7.0 mm, at least about 8.0 mm, at least 9.0 mm, at least 10 mm, at least 15 mm, at least 20 mm, at least 25 mm, at least 30 mm, at least 35 mm, at least 40 mm, at least 45 mm, or at least 50 mm or about 0.4 mm to about 50 mm, about 0.4 mm to about 40 mm, about 0.4 mm to about 30 mm, about 0.4 mm to about 25 mm, about 0.4 mm to about 20 mm, about 0.4 mm to about 15 mm, about 0.4 mm to about 10 mm, about 0.4 mm to about 9 mm, about 0.4 mm to about 8 mm, about 0.4 mm to about 7 mm, about 0.4 mm to about 6 mm, about 0.4 mm to about 5 mm, about 0.4 mm to about 4 mm, about 0.4 mm to about 3 mm, about 0.4 mm to about 2 mm, about 0.4 mm to about 1 mm, about 0.4 mm to about 0.9 mm and about 0.4 to about 0.8 mm. As will be appreciated by one of skill in the art, the expressed penetration depth is in some embodiments the functional depth, specifically, the depth of insertion into the pores or penetration below the surface of the board that is required for the foam to bond mechanically and structurally to the porous structural board.

As a result, the attachment between the structural board and the foam is much stronger than simply securing the foam to a structural board, for example, by use of an adhesive or other similar means that attach at merely a surface level. Specifically, not only a mechanical bond but also a chemical bond forms between the foam and the inner walls of the pores of the structural board, as discussed herein.

As used herein, “pores” of a structural board refers not only to small openings within the board, particularly at the surface of the board, but also to surface imperfections like chips, overhangs and roughness of for example OSB as well as the fibrous surface of some structural boards.

Accordingly, in some embodiments of the invention, the PUR or PIR closed cell, rigid insulation foam is chemically and mechanically bonded directly to the surface and pores, as defined herein, of the porous structural board at a depth or a functional depth of at least about 0.4 mm, at least about 0.5 mm, at least about 0.6 mm, at least about 0.7 mm, at least about 0.8 mm, at least about 0.9 mm or at least about 1 mm, as discussed herein.

Specifically, scanning electron microscopy of cross-sections of the foam-based, structural panel at the transition between the porous structural board, for example, OSB, and the PUR or PIR closed cell, rigid insulation foam was carried out at 29×, 39× and 70× magnification. These images showed a transition of approximately or about 400 um.

Similarly, scanning electron microscopy of cross-sections of the foam-based, structural panel at the transition between the porous structural board, for example, exterior drywall, and the PUR or PIR closed cell, rigid insulation foam was carried out, which also showed a transition of about 400 um.

In some embodiments of the invention, the PUR or PIR closed cell, rigid insulation foam is chemically and mechanically bonded directly to the surface and pores, as defined herein, of the porous structural board at a depth or a functional depth of at least about 0.4 mm, at least about 0.5 mm, at least about 0.6 mm, at least about 0.7 mm, at least about 0.8 mm, at least about 0.9 mm or at least about 1 mm, with the proviso that no adhesive is placed on the surface of the porous structural board. Specifically, as a result of the method described herein, the foam is chemically and mechanically bonded at the surface of the porous structural board and below the surface of the structural board at a depth of at least 0.4 mm to 75 mm by being driven into pores, specifically, holes, chips, overhangs as well as between fibres thereof, the foam reacting chemically at these pores while also expanding, thereby bonding mechanically as well to the porous structural board, such that the foam is bonded directly to the structural board, without any adhesive or added connectors.

As will be appreciated by one of skill in the art, it is very surprising that the PUR or PIR closed cell, rigid insulation foam binding to the porous structural board at a depth of at least about 0.4 mm was sufficient for the foam to be tightly bound to the board, especially without the use of any added adhesive or any mechanical connectors. The benefits of this construction, aside from the cost savings involved in the omission of an adhesive, are discussed herein.

Furthermore, as will be appreciated by one of skill in the art, not any foam can be used in this process. In addition to being a suitable insulation foam, the foam must also have suitable gelation properties to allow for entry of the foam into the pores of the porous structural board, must have a sufficient density so as to not break apart easily during handling and during use and must have a sufficient firmness so as to be rigid enough for use as a foam-based, structural construction panel.

For example, while suitable gelation properties will depend on the specific process used, as well as the process settings, such as, for example, pour time, a suitable gelation time is between about 10 seconds to about 150 seconds or between 10 seconds to 150 seconds.

As will be apparent to those of skill in the art, density and gelation are not directly correlated.

In some embodiments, the density of the foam is about 0.5 pounds per cubic foot (PCF) to about 5 PCF, for example, between about 1.5 PCF to about 3.5 PCF.

In some embodiments, the foam has a firmness range, as measured by compressive strength at 50% of about 150 to about 380 kPa.

As will be apparent to those of skill in the art, as used herein, “insulation foam” refers to a foam that has, for example, low thermal conductivity, high closed cell content, suitable structural properties such as reasonable compressive strength and a reasonable density.

Specifically, closed cell foams have higher R-value as the insulative gas (the blowing agent) gets trapped in the closed foam cells. R-value is also influenced by the type of blowing agent used, as it is what provides low thermal conductivity as well as the thickness of the foam.

In one aspect of the invention, described herein is a method of preparing a foam-based, structural construction panel comprising:
mixing a polyol with additives to form a resin mixture;
blending the resin mixture with a suitable compound comprising isocyanate reactive groups to produce a polyurethane (PUR) or polyisocyanurate (PIR) closed cell, rigid insulation foam;
dispensing the PUR or PIR closed cell, rigid insulation foam onto a porous structural board, said porous structural board in a mold, said mold comprising at least one plate and said mold arranged to contain the PUR or PIR closed cell, rigid insulation foam between the structural panel and an opposite surface of the finished panel;
subjecting the PUR or PIR closed cell, rigid insulation foam on the porous structural board in the mold to suitable temperature for a suitable period of time such that said PUR or PIR closed cell, rigid insulation foam enters into pores of the porous structural board and thereby bonds to the porous structural board, thereby forming a foam-based, structural construction panel.

In some embodiments, the resin mixture is mixed with the suitable compound at a ratio of 0.5-3.5 (w/w).

In some embodiments, the PUR or PIR closed cell, rigid insulation foam has 1-5 pounds per cubic foot free rise density.

In some embodiments, the suitable temperature is from about 30 C to about 100 C. For example, the panel may be subjected to a temperature from about 30 C to about 55 C or from about 35 C to about 55 C or of about 50 C, wherein “about” refers to the base value plus or minus 10%. That is, “about 50” refers to “45-55”. In some embodiments the preferred temperature may be up to about 55 C to about 100 C or about 70 C to about 100 C.

In some embodiments of the invention, the suitable period of time is about 3 to about 20 minutes, for example, about 3 minutes to about 6 minutes or for about 10 minutes to about 20 minutes.

As will be apparent to those of skill in the art, the suitable pressure is, for example, what is needed to maintain the fixed gap against the foam pressure. The constraining resistive force must be equal or greater than the foam pressure to maintain the dimensions of the foam.

The structural board may be any suitable structural board known and/or used in the construction industry, for example, but by no means limited to OSB and drywall.

In some embodiments of the invention, the PUR or PIR closed cell, rigid insulation foam of the foam-based, structural construction panel has a range of about 1 to about 17 pounds per cubic foot, or 1-17 pounds per cubic foot.

In some embodiments of the invention, the compound comprising isocyanate groups is selected from the group consisting of: toluene-di-or-tri-isocyanate; m-xylylene-diisocyanate, -tetraisocyanate; hexamethylene-diisocyanate; diisocyanatediphenyl ethers; 4,4′-diisopropylcyanateodiphenyl; 4,4′-diisocyanato-3,3′-dichlorodiphenyl; 4,4′-diisocyanato-3,3′-dimethoxydiphenyl; 4,4′-diisocyanato-3,3′-dimethyldiphenyl; 4,4′-diisocyanato-3,3′-diphenyldiphenyl; 4,4′-diisocyanato-diphenylmethane; 4,4′-diisocyanato-3,5′-dimethyldiphenylmethane; naphthylene-1,5-diisocyanate; N,N′-(4,4′-dimethyl-3,3′-diisocyanatodiphenyl)uretdione; and 2,4,4′-triisocyanatodiphenyl ether.

As will be apparent to those of skill in the art, a wide variety of polyols may be used within the invention to produce a foam having the desired properties, as discussed above, and as such, are within the scope of the invention.

As used herein, the expression “mold” is to be considered very broadly in terms of it's application and applies to both continuous and discontinuous processes, as discussed herein.

For example, in it's simplest embodiment, a mold comprises two plates that contain or hold the foam between the structural panel and an opposite surface, which may be the top of the foam layer or may be for example a reinforcement layer or a facer, as discussed herein.

Alternatively, the mold may be constructed to utilize the structural panel as one half of the mold by providing a suitable support structure to contain the pressure of the foam against the structural panel.

The mold may have sidewalls to contain the foam on 2 sides (continuous) or 4 sides (non-continuous or batch process).

In one embodiment, the mold may be part of what is known as a continuous panel production machine. In these embodiments, the mold may be formed from individual slats that move on a continuous line, where the slats support the structural panel and contain the pressure of the reacting foam. The continuous line may have side rails or conveyors to contain the foam in a direction perpendicular to the direction of the foam production.

In some embodiments of the invention, the continuous lamination line speed is about 10 ft/min to about 200 ft/min.

In some embodiments, the mold is arranged such that the foam extends beyond the edge of the structural board, for example by about 1/16″ to about ⅜″, as discussed herein.

In some embodiments of the invention, the PUR or PIR closed cell, rigid insulation has a gelation time between about 10 seconds to about 150 seconds, a density of between about 0.5 pounds per cubic foot (PCF) to about 5 PCF and a firmness range, as measured by 50% compressive strength of about 150 to about 380 kPa.

According to another aspect of the invention, there is provided a method of preparing a foam-based, structural construction panel comprising:
mixing a polyol with additives to form a resin mixture;
blending the resin mixture with a suitable compound comprising isocyanate reactive groups to produce a polyurethane (PUR) or polyisocyanurate (PIR) closed cell, rigid insulation foam;
dispensing the PUR or PIR closed cell, rigid insulation foam onto a porous structural board, said porous structural board in a mold, said mold comprising at least one plate and said mold arranged to contain the PUR or PIR closed cell, rigid insulation foam between the structural panel and an opposite surface of the finished panel and sidewalls to contain the foam on four sides;
subjecting the PUR or PIR closed cell, rigid insulation foam on the porous structural board in the mold to suitable temperature for a suitable period of time such that said PUR or PIR closed cell, rigid insulation foam enters into pores of the porous structural board and thereby bonds to the porous structural board, thereby forming a foam-based, structural construction panel.

In some embodiments, the resin mixture is mixed with the suitable compound at a ratio of 0.5-3.5 (w/w).

In some embodiments, the PUR or PIR closed cell, rigid insulation foam has 1-5 pounds per cubic foot free rise density.

In some embodiments, the suitable period of time is about 10 to about 20 minutes.

In some embodiments, the porous structural board is OSB, drywall, plywood, concrete board or magnesium oxide board. As is known to those of skill in the art, these structural panels are well known in the art, as are methods for their production and their physical characteristics, such as pore density and depth, which may vary somewhat.

In some embodiments, the PUR or PIR closed cell, rigid insulation foam of the foam-based, structural construction panel has a range of about 1 to about 17 pounds per cubic foot.

In some embodiments, the compound comprising isocyanate groups is selected from the group consisting of: toluene-di-isocyanate; toluene-tri-isocyanate; m-xylylene-diisocyanate; m-xylylene-tetraisocyanate; hexamethylene-diisocyanate; diisocyanatediphenyl ethers; 4,4′-diisopropylcyanateodiphenyl; 4,4′-diisocyanato-3,3′-dichlorodiphenyl; 4,4′-diisocyanato-3,3′-dimethoxydiphenyl; 4,4′-diisocyanato-3,3′-dimethyldiphenyl; 4,4′-diisocyanato-3,3′-diphenyldiphenyl; 4,4′-diisocyanato-diphenylmethane; 4,4′-diisocyanato-3,5′-dimethyldiphenylmethane; naphthylene-1,5-diisocyanate; N,N′-(4,4′-dimethyl-3,3′-diisocyanatodiphenyl)uretdione; and 2,4,4′-triisocyanatodiphenyl ether.

As will be apparent to those of skill in the art, a wide variety of polyols may be used within the invention to produce a foam having the desired properties, as discussed above, and as such, are within the scope of the invention.

In some embodiments, the mold is a pressure or clamshell mold.

In some embodiments of the invention, the PUR or PIR closed cell, rigid insulation has a gelation time between about 10 seconds to about 150 seconds, a density of between about 0.5 pounds per cubic foot (PCF) to about 5 PCF and a firmness range, as measured by 50% compressive strength of about 150 to about 380 kPa.

According to another aspect of the invention, there is provided a method of preparing a foam-based, structural construction panel comprising:
mixing a polyol with additives to form a resin mixture;
blending the resin mixture with a suitable compound comprising isocyanate reactive groups to produce a polyurethane (PUR) or polyisocyanurate (PIR) closed cell, rigid insulation foam;
dispensing the PUR or PIR closed cell, rigid insulation foam onto a porous structural board, said porous structural board in a mold, said mold comprising at least one plate and said mold arranged to contain the PUR or PIR closed cell, rigid insulation foam between the structural panel and an opposite surface of the finished panel and sidewalls to contain the foam on two sides;
subjecting the PUR or PIR closed cell, rigid insulation foam on the porous structural board in the mold to suitable temperature for a suitable period of time such that said PUR or PIR closed cell, rigid insulation foam enters into pores of the porous structural board and thereby bonds to the porous structural board, thereby forming a foam-based, structural construction panel.

In some embodiments, the resin mixture is mixed with the suitable compound at a ratio of 0.5-3.5 (w/w).

In some embodiments, the PUR or PIR closed cell, rigid insulation foam has 1-5 pounds per cubic foot free rise density.

In some embodiments, the suitable temperature is about 55 C to about 100 C.

In some embodiments, the suitable period of time is about 3 minutes.

In some embodiments, the porous structural board is OSB or drywall.

In some embodiments, the PUR or PIR closed cell, rigid insulation foam of the foam-based, structural construction panel has a range of about 1 to about 17 pounds per cubic foot.

In some embodiments, the compound comprising isocyanate groups is selected from the group consisting of: toluene-di-isocyanate; toluene-tri-isocyanate; m-xylylene-diisocyanate; m-xylylene-tetraisocyanate; hexamethylene-diisocyanate;

diisocyanatediphenyl ethers; 4,4′-diisopropylcyanateodiphenyl; 4,4′-diisocyanato-3,3′-dichlorodiphenyl; 4,4′-diisocyanato-3,3′-dimethoxydiphenyl; 4,4′-diisocyanato-3,3′-dimethyldiphenyl; 4,4′-diisocyanato-3,3′-diphenyldiphenyl; 4,4′-diisocyanato-diphenylmethane; 4,4′-diisocyanato-3,5′-dimethyldiphenylmethane; naphthylene-1,5-diisocyanate; N,N′-(4,4′-dimethyl-3,3′-diisocyanatodiphenyl)uretdione; and 2,4,4′-triisocyanatodiphenyl ether.

As will be apparent to those of skill in the art, a wide variety of polyols may be used within the invention to produce a foam having the desired properties, as discussed above, and as such, are within the scope of the invention.

In some embodiments, the mold is formed from individual slats that move on a continuous line, where the slats support the structural panel and contain the pressure of the reacting foam.

In some embodiments, the method comprises a continuous lamination line.

In some embodiments, the continuous lamination line speed is about 10 ft/min to about 200 ft/min.

In some embodiments, the continuous lamination line has side rails or conveyors to contain the foam in a direction perpendicular to the direction of the foam production.

In some embodiments, the continuous lamination line has a moving conveyor and into a lamination tunnel of set gap.

In some embodiments of the invention, the PUR or PIR closed cell, rigid insulation has a gelation time between about 10 seconds to about 150 seconds, a density of between about 0.5 pounds per cubic foot (PCF) to about 5 PCF and a firmness range, as measured by 50% compressive strength of about 150 to about 380 kPa.

According to another aspect of the invention, there is provided a foam-based, structural panel prepared according to any one of the methods described above.

In some embodiments, the foam-based, structural panel has a thickness of about 1 inch to about 3 inches or of 1 inch to 3 inches or of 2 inches or less or about 2 inches. As a result of this arrangement, framers and siders can use nail guns and not screws to mount the panels which is more expensive and time-consuming. Specifically, framers and siders can use the same saws and nails to be used with their standard nail guns, which means better workability.

Yet further, use of the foam-based structural panel as described herein, specifically, as a replacement for an insulated sheathing product for building construction, helps in creating an air barrier. This is accomplished by expanding the foam beyond the edge of the porous structural board, for example, by about 1/16″ (one sixteenth of an inch) to about ⅜″ (three eights of an inch) as discussed herein, so that when the foam-based, structural panels are installed together, the joints of the panels butt together and keep air out. This is key to reduce air exchanges in any building, be it cold air or hot air. Specifically, as will be apparent to those of skill in the art, this arrangement provides high performance without having to tape the joints.

Furthermore, thicker foam will create more R-value which in turn improves the performance of the wall as it is better to have more insulation on the outside of the wall to the inside. Furthermore, the foam-based, structural panels have a high effective R-value as, in use, the panels are fastened on the outside of the studs to reduce thermal bridging, which creates a continuous insulation, increasing the effective R-value and holding the radiant temperature of the exterior walls for higher inside comfort.

Furthermore, the finished panels are more durable as the foam is encapsulated between the backer and the facer board. This makes the panels better for transport and storage as well as more durable on job sites.

Yet further, as a result of this arrangement, the foam of the finished panel keeps the surface of the structural board warmer which in turn reduces condensation, which in turn makes the panels more resistant to mold growth, particularly where the facer is a non-mold-growing surface.

In some embodiments of the invention, a fire-retardant composition, for example, ammonium polyphosphate (APP) and/or alumina trihydrate (ATH) is added to the first mixture. Alternatively, other suitable fire retardants may be added to for example the first mixture and are within the scope of the invention.

As a result of this arrangement, the foam-based, structural panel has a flame spread rating under 25 and a smoke density rating under 450. Consequently, the foam-based, structural panels have improved performance during a fire or a better fire rating than, for example, syrofoam, EPS or XPS products.

In some embodiments of the invention, the permeability of the foam is greater than one or greater than about 1, which allows for better vapour permeability. As will be known to those of skill in the art, this is related to the density of the foam being used as a denser foam or even just packing more foam in the mold will produce a denser end product which in turn will have a lower permeability.

In some embodiments of the invention, the OSB is ⅜″ OSB.

In some embodiments of the invention, the drywall is exterior drywall, for example, ½″ or ⅝″ exterior drywall.

In some embodiments of the invention, the foam-based construction product is dispensed into the pressure or clamshell mold wherein the mold comprises more than one, for example, two or more or two structural boards. For example, the foam-based construction product may comprise, in these embodiments, a first porous structural board of for example exterior drywall or OSB and a second porous structural board. In some embodiments of the invention, instead of a second structural board, a

facer, for example, a wood veneer or a fibre and/or paper facer product is used.

As will be apparent to those of skill in the art, the facer is intended to be “interior-facing” and the drywall or OSB structural board is intended to be “exterior-facing”.

The facer may be a porous facer.

In some embodiments, the facer may be 200 to 600 g/m² calcium carbonate coated fiberglass.

As will be apparent to one of skill in the art, the veneer may be any suitable veneer known in the art, for example, ⅛″ veneer.

In some embodiments, the veneer is pressure-treated with a suitable preservative, either before or after pressure bonding to the polyol foam.

In some embodiments of the invention, the foam-based construction product is produced with the proviso that no separate water-proofing layer is provided or otherwise attached to an exterior-facing surface thereof. Specifically, as will be appreciated by one of skill in the art, water-proofing is provided by the suitable rigid foam.

While the preferred embodiments of the invention have been described above, it will be recognized and understood that various modifications may be made therein, and the appended claims are intended to cover all such modifications which may fall within the spirit and scope of the invention.

1. A method of preparing a foam-based, structural construction panel comprising:
mixing a polyol with additives to form a resin mixture;
blending the resin mixture with a suitable compound comprising isocyanate reactive groups to produce a polyurethane (PUR) or polyisocyanurate (PIR) closed cell, rigid insulation foam;
dispensing the PUR or PIR closed cell, rigid insulation foam onto a porous structural board, said porous structural board in a mold, said mold comprising at least one plate and said mold arranged to contain the PUR or PIR closed cell, rigid insulation foam between the porous structural board and an opposite surface of the foam-based, structural construction panel;
subjecting the PUR or PIR closed cell, rigid insulation foam on the porous structural board in the mold to suitable temperature for a suitable period of time such that said PUR or PIR closed cell, rigid insulation foam enters into pores of the porous structural board and thereby bonds chemically and mechanically at and below the surface of the porous structural board, thereby forming a foam-based, structural construction panel.

2. The method according to claim 1 wherein the resin mixture is mixed with the suitable compound at a ratio of 0.5-3.5 (w/w).

3. The method according to claim 1 wherein the PUR or PIR closed cell, rigid insulation foam has 1-5 pounds per cubic foot free rise density.

4. The method according to claim 1 wherein the suitable temperature is from about 30 C to about 100 C.

5. The method according to claim 4 wherein the suitable temperature is from about 30 C to about 55 C.

6. (canceled)

7. (canceled)

8. The method according to claim 1 wherein the suitable period of time is about 3 to about 20 minutes.

9. The method according to claim 1 wherein the porous structural board is OSB, drywall, plywood, concrete board or magnesium oxide board.

10. The method according to claim 1 wherein the PUR or PIR closed cell, rigid insulation foam of the foam-based, structural construction panel has a range of about 1 to about 17 pounds per cubic foot.

11. The method according to claim 1 wherein the compound comprising isocyanate groups is selected from the group consisting of: toluene-di-isocyanate or toluene-tri-isocyanate; m-xylylene-diisocyanate, m-xylylene -tetraisocyanate; hexamethylene-diisocyanate; diisocyanatediphenyl ethers; 4,4′-diisopropylcyanateodiphenyl; 4,4′-diisocyanato-3,3′-dichlorodiphenyl; 4,4′-diisocyanato-3,3′-dimethoxydiphenyl; 4,4′-diisocyanato-3,3′-dimethyldiphenyl; 4,4′-diisocyanato-3,3′-diphenyldiphenyl; 4,4′-diisocyanato-diphenylmethane; 4,4′-diisocyanato-3,5′-dimethyldiphenylmethane; naphthylene-1,5-diisocyanate; N,N′-(4,4′-dimethyl-3,3′-diisocyanatodiphenyl)uretdione; and 2,4,4′-triisocyanatodiphenyl ether.

12. (canceled)

13. The method according to claim 1 wherein the mold further comprises sidewalls to contain the foam on four sides.

14. The method according to claim 1 wherein the mold further comprises sidewalls to contain the foam on at least two sides.

15. The method according to claim 14 wherein the mold is formed from individual slats that move on a continuous line, where the slats support the structural panel and contain the pressure of the reacting foam.

16. The method according to claim 15 wherein the method comprises a continuous lamination line.

17. (currently amended The method according to claim 16 wherein the continuous lamination line speed is about 10 ft/min to about 200 ft/min.

18. The method according to claim 16, wherein the continuous lamination line has side rails or conveyors to contain the foam in a direction perpendicular to the direction of the foam production.

19. The method according to claim 18 wherein the continuous lamination line has a moving conveyor and into a lamination tunnel of set gap.

20. (canceled)

21. A method of preparing a foam-based, structural construction panel comprising:
mixing a polyol with additives to form a resin mixture;
blending the resin mixture with a suitable compound comprising isocyanate reactive groups to produce a polyurethane (PUR) or polyisocyanurate (PIR) closed cell, rigid insulation foam;
dispensing the PUR or PIR closed cell, rigid insulation foam onto a porous structural board, said porous structural board in a mold, said mold comprising at least one plate and said mold arranged to contain the PUR or PIR closed cell, rigid insulation foam between the porous structural board and an opposite surface of the foam-based structural construction panel and sidewalls to contain the foam on four sides;
subjecting the PUR or PIR closed cell, rigid insulation foam on the porous structural board in the mold to suitable temperature for a suitable period of time such that said PUR or PIR closed cell, rigid insulation foam enters into pores of the porous structural board and thereby bonds chemically and mechanically at and below the surface of the porous structural board, thereby forming a foam-based, structural construction panel.

22. (canceled)

23. (canceled)

24. The method according to claim 21 wherein the suitable period of time is about 10 to about 20 minutes.

25. (canceled)

26. (canceled)

27. (canceled)

28. (canceled)

29. (canceled)

30. A method of preparing a foam-based, structural construction panel comprising:
mixing a polyol with additives to form a resin mixture;
blending the resin mixture with a suitable compound comprising isocyanate reactive groups to produce a polyurethane (PUR) or polyisocyanurate (PIR) closed cell, rigid insulation foam;
dispensing the PUR or PIR closed cell, rigid insulation foam onto a porous structural board, said porous structural board in a mold, said mold comprising at least one plate and said mold arranged to contain the PUR or PIR closed cell, rigid insulation foam between the porous structural board and an opposite surface of the foam-based, structural construction panel and sidewalls to contain the foam on two sides;
subjecting the PUR or PIR closed cell, rigid insulation foam on the porous structural board in the mold to suitable temperature for a suitable period of time such that said PUR or PIR closed cell, rigid insulation foam enters into pores of the porous structural board and thereby bonds chemically and mechanically at and below the surface of the porous structural board, thereby forming a foam-based, structural construction panel.

31. (canceled)

32. (canceled)

33. The method according to claim 30 wherein the suitable temperature is about 55 C to about 100 C.

34. The method according to claim 30 wherein the suitable period of time is about 3 minutes to about 6 minutes.

35. (canceled)

36. (canceled)

37. (canceled)

38. (canceled)

39. (canceled)

40. (canceled)

41. (canceled)

42. (canceled)

43. (canceled)

44. The method according to claim 1, wherein the PUR or PIR closed cell, rigid insulation foam has a gelation time between about 10 seconds to about 150 seconds.

45. The method according to claim 1, wherein the PUR or PIR closed cell, rigid insulation foam has a density of between about 0.5 pounds per cubic foot (PCF) to about 5 PCF.

46. The method according to claim 1, wherein the PUR or PIR closed cell, rigid insulation foam has a firmness range, as measured by 50% compressive strength of about 150 to about 380 kPa.

47. The method according to claim 1, characterised in that the PUR or PIR closed cell, rigid insulation foam bonds chemically and mechanically below the surface of the porous structural board at a depth of about 0.4 mm to about 75 mm.

48. The method according to claim 47 characterised in that the PUR or PIR closed cell, rigid insulation foam bonds chemically and mechanically below the surface of the porous structural board at a functional depth of about 0.4 mm to about 5 mm.

49. (canceled)

50. (canceled)

51. (canceled)

52. (canceled)
